(19) United States
(12) Patent Application Publication
(10) Pub. No.: US 2006/0049649 A1
(43) Pub. Date: Mar. 9, 2006

(54) Process to manufacture a coated bumper

(75) Inventors: Sergio Pablo Ortiz-Garcia, Comonfort (MX); Jose Enriquez-Gomez, Celaya (MX); Ricardo Morales-Coronilla, Jauregui Municipio de Celaya (MX)

Correspondence Address: BROWDY AND NEIMARK, P.L.L.C.;624 NINTH STREET, NW, SUITE 300, WASHINGTON, DC, 20001-5303, US

(73) Assignee: Pintura, Estampado Y Montaje, S.A. DE, Celaya (MX)

(21) Appl. No.: 11/055,010

(22) Filed: Feb. 11, 2005

(30) Foreign Application Priority Data
Feb. 12, 2004 (MX) PA/A/2004/001331

(51) Int. Cl. B60R 19/02

(52) U.S. Cl. 293/102

(57) ABSTRACT

This invention relates to a process for the manufacture a coated bumper, which steps are practical and simple, but at the same time, highly efficient for manufacturing coated bumpers, that permits the use of same equipment as those used to manufacture conventional fences. Likewise, this invention relates to a bumper highly efficient for use in any type of vehicle, since it has and exceeds all the aesthetical and mechanical and corrosion resistance characteristics of bumpers found in the state of the art.

### FIELD OF THE INVENTION

This invention relates to the techniques used in manufacturing spare parts used in the Automotive Industry, and more specifically, relates to a process to manufacture a coated bumper, as well as the bumper obtained through such a process.

### BACKGROUND OF THE INVENTION

As, it is widely known in the fields of the Automotive Industry, bumpers or fenders are an essential protection building block for any type of vehicle such as compact automobiles, light trucks, pick-ups, trucks, trailers, among others, since in case of a frontal car crash, bumpers receive in first place all the impact energy; this is the reason of their name and reason for which they must comply with a series of extremely strict safety standards.

According to the prior art, bumpers are manufactures from a metal plate subjected to a process involving a first shaping step where metal plate is mould by die presses or stamping machines having as purpose to give the plate the shape of a desired bumper; then a step of physical and/or chemical cleaning where the bumper surface is prepared to receive a surface finishing; and finally, a finishing step where the bumper is painted or subjected to a process to cover it with chrome in order to give the bumper a visually appealing finishing to the bumper, and in harmony with the rest of the vehicle. Finally, bumpers are inspected, packed and delivered to automobile assembly facilities, agencies, spare part dealers, etc.

As to the chromium plating process, it is worth mentioning that it is one of the most used resorts to give metal bumpers the aesthetical and protection characteristics, since it allows delaying corrosion. Due to the inherent characteristics of the galvanoplastics process, waste waters of the chromium plating process are characterized by the high content of heavy metals and highly environmental pollutant substances, since if in place there is no water treatment facility, which in turn, produce mud characterized as dangerous residues requiring disposal pursuant to the environmental guidelines, such waters will end in receiving bodies. In addition, to get acceptable chromium plating, it is necessary to carry out the electrochemical cleaning of the bumper, releasing into the environment substances such as caustic soda and oils; likewise, during electrolytic chromium plating, there are effluents discharges that contain heavy metal compounds such as chromium, nickel, copper, etc. Due to such environmental problems, the trend of the Automotive Industry in recent years has been to eliminate chromium-plated spare parts.

The process to get a chromium-plated bumper includes these steps: (a) carbon stamping of a metal plate to give desired shape; (b) pre-polishing step to eliminate surface roughness and attempt to get a glossy surface; (c) a first step for mechanical cleaning and degreasing with detergent solutions; (d) a second step for cleaning in electro-chemical coating, so that the surface remains prepared to receive the chromium film; (e) during the next step, the chromium film is applied to the bumper by using a galvanoplastics process at one or several steps that may include successive copper and nickel coatings before the chromium coating; (f) a step for final cleaning to eliminate substances of the electrolytic process; (g) a following step for visual inspection so to pack the bumper and deliver it to final destination, which can be either an assembly facility, or else, a spare parts dealer.

In addition to those mentioned above, it is worth mentioning that chromium-plated bumpers have another type of problem relating to their wear and tear; for instance, when a vehicle is traveling on freeways and highways, small-sized stones and particles are projected against and impact the bumpers at high speeds, thereby cracking and removing portions off the chromium plating. It is worth mentioning as well that such plating is rather thin and its hardness renders it brittle against the impacts, thereby exposing unprotected areas of the metal plate in the open, wherein the corrosion can quickly begin and, consequently, the bumper weakens and deteriorates. Such corrosion phenomenon is quite notorious and speeds up at places with extreme climates, particularly where salt is employed during the winter to prevent ice from forming on the pavement, or at coastal and industrial areas that face corrosive or humid atmospheres.

An additional disadvantage of chromium-plated bumpers deals with the production costs, this is so because to get a high-reflectivity finishing (“mirror degree”) or similar degree, it is required that the base metal plate is perfectly polished and cleaned, and thus clearly increasing production and labor costs. On the contrary, a deficient polishing or cleaning would make the chromium plating to show imperfections in the base metal, and thus causing the chromium plating not to have the desired optical characteristics, and therefore, making the bumper to lessen its commercial and aesthetical value.

On the other hand, bumpers getting a paint-based finishing also have problems regarding poor impact resistance to small particles or stones at high speeds; therefore, the lasting of such painted finishing is limited, making it necessary to provide it with a continuous maintenance by frequently painting such bumper, in extreme cases. Lastly, from the aesthetical point of view, a painted bumper is less appealing than a chromium-plated bumper; this characteristic represents a drawback. The process to get a painted bumper is not much different from that of a chromium-plated bumper and consists of the following steps: (a) carbon stamping of a steel plate to give the desired shape; (b) then the step for cleaning by degreasing with alkaline solutions free of detergents; (c) and then application of an anticorrosion, material coating; (d) then a visual inspection step for its following packing and final deliver,to assembly facility where it is paint-coated according to the color of the chassis; and thereafter, to be assembled.

Aimed at manufacturing bumpers with acceptable appearance, in the state of the art, attempts have been made to manufacture bumpers completely made by, stainless steel; however, raw material costs make it unaffordable.

In this sense, attempts have been also made to manufacture bumpers completely made by aluminum; however, due to the less hardness of such metal, make their surfaces to be damages by gratings with minor impacts and contacts normally experienced in daily use of vehicles. In addition to the above, there is the fact that aluminum plates have processing problems when it is desired to shape hollows such as for plate holders, or breaks in the bumper through shaping processes such as the stamping. In particular, aluminum plates lose their optical characteristics when such hollows are shaped; in addition, they fail to reach the required brightness appearance.

In the state of the art it is possible to find bumpers with special arrangements of more than one metal plate, such as a truck bumper outlined in U.S. Pat. No. 6,325, 430, the main objective of which is to provide a truck bumper that may be fixed to its chassis without having to drill the bumper surface. More specifically, such document describes a truck bumper with an external surface having a specified mechanical finishing, such as the highly reflective finishing (mirror finishing), which is uniform in appearance and has no unwanted holders or hollows extending through the bumper. It includes an external plate and a reinforcing plate generally configured similarly to the external plate with a “U”-shaped channel and placed in the break of the channel configured similarly to the external plate. Reinforce plate is welded to he external plate and has crevices, each with a hole where its holder extends. Each holder head is securely and totally clamped in the reinforcing sheet in such a way it doesn't blocks or interferes with the uniform appearance of the highly reflective finishing of the external plate.

As can be observed in the above foreign patent document, external plate presents a practically flat surface and must have a recess channel to receive the reinforcing plate which includes crevices for the holders; such configuration especially made for the truck bumper shows a drawback since it desires to manufacture bumpers for other type of vehicles, such as pickup and light truck bumpers, in which said bumpers commonly include external breaks or gaps for footboards or plate holders. Likewise, it may be noted that the reinforcing plate must have a surface profile different to that of the external plate; due to such surface difference each plate must be manufactured by using a different mould; in addition, placement of holders clamping the bumper to the rest of the truck must be carried out before welding reinforce plate to the external plate. This fact result in additional labor and costs, and thus, from an expense point of view, this type of bumpers is much more expensive.

There are other materials and processes to manufacture bi-metal bumpers or fences such as that including the next steps: (a) the first step to depart from is a stainless steel material coupled to a carbon aluminum or steel substratum, where such compound material is obtained through a process known as “clad” (b) in the next step, the compound material is given desired shape through a mint or stamping process; (c) in the next step, it is given a mechanical cleaning with detergent solutions on the carbon steel face; (d) a masking step, for which purpose adhesive tapes of films are used to prevent anticorrosion coating from fixing to the stainless steel face; (d) in the following step, an anticorrosion material coating is applied; (f) a finishing step correcting by polishing such imperfections caused by the process in the stainless steel surface; (g) finally, it is packed and delivered to the assembly facility or spare part dealers.

According to above descriptions, it can be seen that by one hand, chromium-plated bumpers present aesthetical problems that with the elapse of time become corrosion problems since, as mentioned above, when chromium-plated bumpers are in use, stones or other particles thrown at high speeds against the surface, cause them “skinning” problems or the formation of small cracks or pores in the chromium coating, resulting in corrosion starting points. Additionally, chromium-plated bumpers present another important drawback: during the chromium-plating process there are releases into the environment of effluents with highly pollutant substances.

While, on the other hand, bumpers with a painting finishing also have such drawback of not being as appealing to the end users from the aesthetical point of view.

Due to the above statements, attempts have been made to eliminate disadvantages of conventional automotive bumpers or fences found in the state of the art by developing a process to manufacture a coated bumper, a highly practical, simple and economical process since it allows to use the same equipment used in manufacturing traditional bumpers, but with the great advantage of not presenting problems caused by releasing effluents with pollutant substances into the environment, as it is the case of electrochemical chromium-plating processes, which are noxious for the living organisms. On the other hand, such bumper obtained with the process of this invention presents the aesthetical and corrosion-resistance characteristics of chromium-plated bumpers or fences, and thus, satisfactorily complying with safety and quality standards required to be used in any type of vehicle.

### OBJECTS OF THE INVENTION

Having regard to the defects stated in the prior art, it is this invention object to provide a process to manufacture a coated bumper highly economical and with practical and simple steps, but at the same time, highly efficient for manufacturing coated bumpers since bumpers obtained through this process present aesthetical, mechanical and corrosion-resistance characteristics of chromium-plated fences.

Another object of this invention is to provide a process for manufacturing a coated bumper allowing for the use of same equipments as those used in manufacturing conventional bumpers.

An additional object of this invention is to provide a process to get a coated bumper permitting to preserve the environment, since the obtained product by such process requires no electrochemical finishing that release heavy metal effluents.

Moreover, another object of this invention is to provide a coated bumper the construction of which is highly simple, practical and cost-efficient, but at the same time, highly efficient to be used in any type of vehicle since it presents and outshines al the aesthetical and mechanical and corrosion-resistance characteristics of bumpers found in the state of the art.

### BRIEF DESCRIPTION OF THE FIGURES

The novel aspects regarded as distinctive of this invention will be set out to detail in the attached claims. However, the invention itself, both due to its process and operating method together with other of its objects and benefits, will be better grasped in the following and detailed description when reading as to the drawings attached hereto, where:

FIG. 1 is a block diagram depicting the step sequence of a process to manufacture a coated bumper, outlined pursuant to the principles of a description particularly specific to this invention.

FIG. 2 is a block diagram depicting the step sequence of a process to manufacture the coated bumper, outlined pursuant to the principles of a first alternative description of this invention.

FIG. 3 is a front elevation view of a bi-metal substratum obtained from one of the steps in the process to manufacture the coated bumper outlined in the first alternative description of this invention.

FIG. 4 is a top front perspective view of the coated bumper, built according to the principles of a description particularly specific to this invention.

FIG. 5 is a front blowup elevation view of the coated bumper depicted in FIG. 4, showing its constituent elements.

FIG. 6 is a back blowup elevation view of the coated bumper shown in FIG. 4.

FIG. 7 is a cross sectional view taken from throughout the A-A′ line of the coated bumper depicted in FIG. 4.

FIG. 8 is a top perspective view of a coated bumper built in accordance with the additional description of this invention.

### DETAILED DESCRIPTION OF THE INVENTION

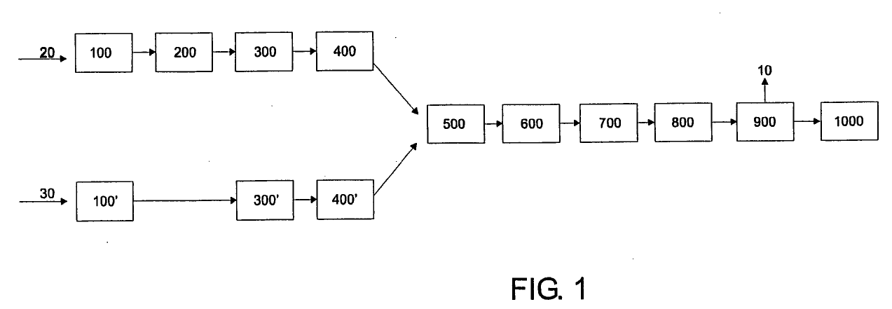

Now referring to the attached drawings, and more particularly to FIG. 1, it depicts a block diagrams showing the several steps of a process to manufacture a coated bumper 10, outlined according to a description particularly specific to this invention, which it is described as an enumeration but not as a limitation of it, which it includes the following steps:

(a) stamp (100) a first metal plate 20 to get an internal base or element 40 of the coated bumper 10, which remains hidden when such bumper 10 is assembled to a vehicle (not shown in the figures) such first metal plate 20, is made of a carbon steel material selected among Series SAE 10XX steels.

(b) apply (200) in at least one of the internal element surfaces 40, a film 60 of the anticorrosion material, which can be either a water or solvent-based painting and applied through any of the methods selected among, electro-deposition, aspersing (spraying), immersion, using a paint-brush, or through any other known application method. In the specific description outlined in this invention, the anticorrosion film 60 is applied in the internal element face 40 exposed to open air once the bumper 10 is assembled to the vehicle;

(c) clean (300) the internal element 40 to remove any type of grease or impurity in its faces, and for such purpose, internal element 40 is subjected to a degreasing process to remove dust and any type of grease left after application of anticorrosion film;

(d) place (400) on the other internal face of element 40 an adhesive material serving as a coupling means that is applied through any of known application methods such as spraying (aspersing), use of a paint-brush, extrusion, immersion, among others. In the specific description of this invention, the application is preferably carried out by an extrusion dosage device that follows the shape of the part in automation application. Adhesive material is selected among acrylic, cyano-acrylate, epoxic, urethanic adhesives or any other adhesive capable of securely coupling a stainless steel material to a carbon steel material;

(e) stamp (100′) separately, a second metal plate 30, to get a coating or external element 50 that rests in the conspicuous portion of the coated bumper 10, when it is already assembled to the vehicle, which has the same shape as the internal element 40, but with slightly greater dimensions than said internal element 40; such second metal plate 30, is made of a stainless steel material with an elongation of at least 40$, which is selected among Series 300 stainless steels, preferably using AISI 304, stainless steel;

(f) clean (300′) the external element to remove any type of grease and impurities left on its faces; for such purpose, the external element 50 is subjected to a mechanical cleaning process with solvent and/or detergent solution, then rinse off and dry;

(g) place (400′) over the face of the external element 50 to be coupled with the adhesive material, which is applied through any known application method such as spraying (aspersing), use of a paint-brush, extrusion, immersion, among others. In the specific description for this invention, application is carried out preferably through an extrusion dosing device that follows the part in automation application, where the face to be coupled is opposite to the visible face. Adhesive material is selected among acrylic, cyano-acrylate, epoxic, urethanic adhesives or any other adhesive capable to securely couple metal materials.

(h) assemble (500) the internal element 40 and the external element 50 to form the coated bumper 10; to that end, the face to be couples of the external element 50 is coupled to the face to be coupled of the internal element 40 by exerting pressure through a press harness keeping the coupling of both parts together with the separation between each other and requiring such adhesive to achieve optimal adherence and resistance that is between 0.02 to 1.2 mm;

(i) pre-cure (600) adhesive material, where coated bumper 10 obtained in the previous step is subjected to a setting process to attain maximum adherence and resistance, duration and temperature of which depend on the type of adhesive material used to carry out the assemble;

(j) reinforce (700) coupling of the external element 50 with the internal element 40; for this purpose any coupling method selected among locking, use of rivets, nuts and bolts, welding points, or a combination of them, among others. In the process outlined for the specific description of this invention, the locking method in used; for this purpose, the external element material 50 emerging from the internal element 40 is folded inwards on the perimeter of such internal element 20;

(k) polish (800) the visible face of the external element 50, to provide, or else, recover such “mirror degree” reflective finishing or any other degree damaged during the stamping and assembly process; polishing can be performed by brushing or any other polishing mechanical process known;

(l) visually inspect (900) the coated bumper 10, to detect any appearance or dimensional defect since surface of visible face must be free of cracks, dents, skin, die marks, etc.;

(m) pack (1000) the coated bumper 10 in order for it to be set and delivered to the assembly facility to be assembled into the vehicle; or else, for its delivery to spare part dealers or license holders of assembly marks.

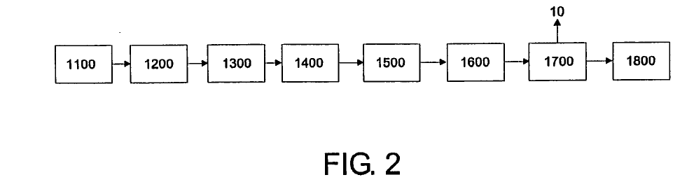

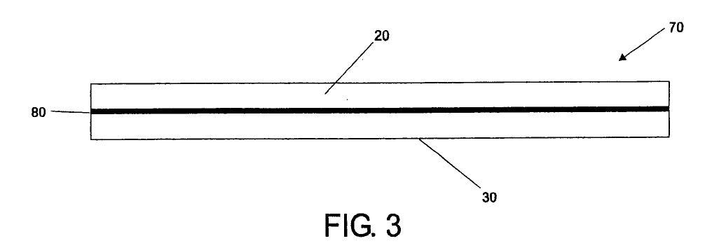

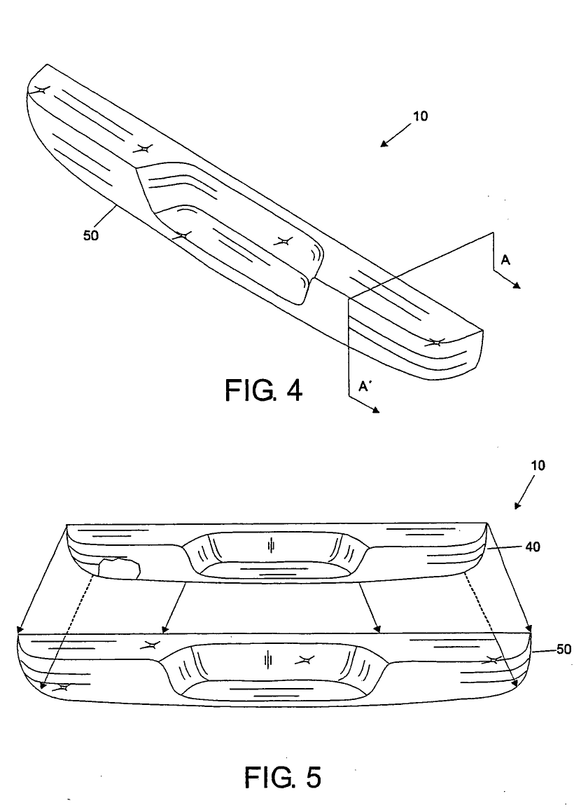

Now then, specifically referring to FIG. 2 of the drawings attached hereto, such figure depicts a block diagram indicating the step sequence of an alternative process to manufacture the coated bumper 10, which is outlined according to the principles of a first alternative description of this invention, and consisting of the following steps: (a) place (1100) the adhesive material on one of the faces of the first metal plate 20, and of the second metal plate 30, where such adhesive material is selected among acrylic, cyano-acrylate, epoxic, urethanic adhesives, or among other adhesives capable to firmly coupling stainless steel to a carbon steel material; (b) couple (1200) the first metal plate 20, to the second metal plate 30, by exerting pressure on them to achieve a good coupling among each other and thus, forming a bi-metal substratum 70,; (c) pre-cure (1300) the adhesive material film 80; for this purpose, said bi-metal substratum 70 obtained in the previous step, is subjected to a setting process to attain maximum adherence and resistance between both parts, where duration and temperature depend on the type of adhesive material used for assembly; (d) stamp (1400) the bi-metal substratum 70 to get the coated bumper 10; (e) clean (1500) the coated bumper 10, to remove any type of grease and impurities left on their faces; for this purpose, the coated bumper 10, is subjected to a mechanical cleaning process with solvent and/or with a detergent solution, rinse off and then dry; (f) polish (1600) the conspicuous face of the coated bumper 10, to provide, or else, recover the “mirror degree” reflective finishing, or any other degree damaged during the stamping process; said polishing can be performed by brushing or any other known mechanical polishing process; (g) visually inspect (1700) the coated bumper 10, to detect any appearance or dimensional defect, since the visible face of coated bumper 10, must be free of cracks, dents, skin, die marks, etc.; (h) pack (1800) the coated bumper 10, in such a way it is set to be delivered to the assembly facility in order to be assembled into the vehicle; or else, deliver it to the spare part dealers or to license holders of assembly marks.

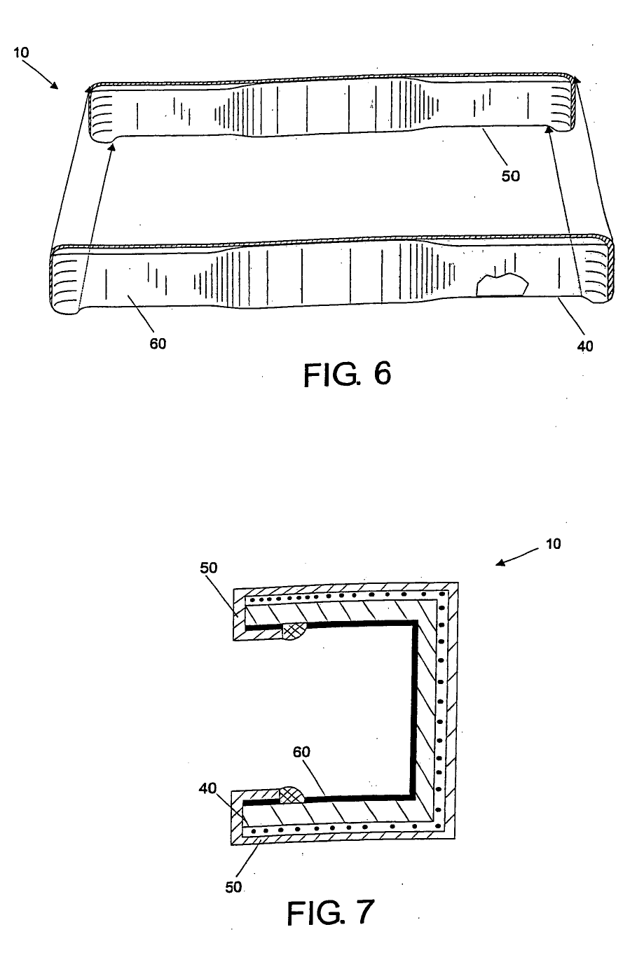

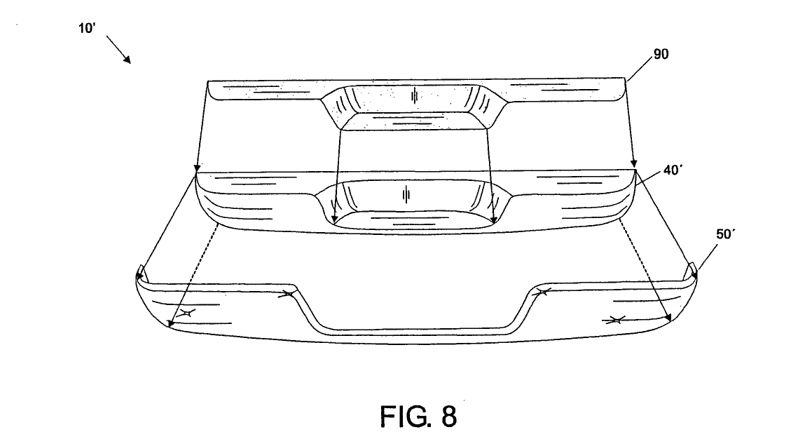

Referring more particularly to FIGS. 6 to 7 of drawings attached hereto, such figures depict the coated bumper 10 obtained through the process outlined in the description particularly specific for this invention, which consists in general terms, of: the internal element 40 or base, that as indicated by its name, is placed in the internal and hidden part of the bumper 10, when it is assembled in the vehicle; such internal element 40, includes in at least of its faces, an anticorrosion material film 60; the external element 50 or coating located on the internal element, 50 of the bumper 10, forming the visible part of said bumper 10; such internal 40 and external 50 elements, are securely coupled by means of an adhesive material film 80.

The internal element 40 can be of any shape, in such a way to totally cover the front part of vehicle for which it was designed. The internal element 40 is made from a carbon steel metal plate selected between Series SAE 10XX steels.

The external element 50 is a complementary shape to the shape of internal element 40, totally or partially covering such internal element 40; therefore, such external element 50 can have equal dimensions or slightly grater than said internal element 40. In the specific description outlined in this invention, the external element 50 is of an equal shape but with dimensions slightly grater than such internal element 40, in such a way that said external element can be perfectly coupled on such internal element 40 to shape the coated bumper 10 of this invention. The external element 50 is made from a metal shape, preferably made of stainless steel with a highly-reflective mechanical finishing, polished to mirror degree, as well as an elongation of at least 40%, in such a way it loses no of its reflective properties or surface uniformity when the material is subjected to the stamping process;, as a result, such stainless steel is selected among Series 300 stainless steels, preferably using AISI 304 stainless steel.

The anticorrosion material film 60 of the internal element 40, is applied on the face exposed to open air when bumper 10 is assembled to the vehicle.

Since dimensions of external element 50 are slightly greater than those of the internal element 40, the material emerging from such external element forms a flap that folds inwards and over the profile of such internal element 40, so that the coupling is reinforced and thus, preventing the external element 50 from separating from the internal element 40 when coated bumper 10 of this invention is assembled to the vehicle, and this vehicle is already servicing.

In additional descriptions of this invention, the couple reinforcement can be made by any other known coupling method, such as using passers or non-passers, nuts and screws, welding, among others.

Now then, referring more specifically to FIG. 9 of the drawings attached hereto, said figure depicts a coated bumper 10′ built pursuant to an additional description to this invention, which is obtained through the manufacturing processes above described in the specific and first alternative description, respectively, of this invention. The coated bumper 10′, consists in general terms, of the following: an internal element 40′ or base located in the internal and hidden portion of the bumper 10′ when it is assembled to a vehicle; such internal element 40′ includes in at least one of its faces, an anticorrosion material film; an external element 50′ or coating located on the internal element 40′ of the bumper 10′, forming the visible part of such bumper 10′; such internal 40′ and external 50′ elements, are securely coupled by an adhesive material film.

The internal element 40′ is made from a carbon steel metal plate selected among Series SAE 10XX steels.

The external 50′ element is of a shape different to the shape of internal element 40′, and partially covers such internal element 40′; however, they couple with each other in a practical and simple manner. External element 50′ is made from a metal plate, preferably a stainless steel plate with a highly-reflective mechanical finishing, polished, to mirror degree, as well as with an elongation of at least 40%, so that it loses none of its reflective properties or surface uniformity when said material is subjected to the stamping process; therefore, stainless steel is selected among Series 300 stainless steels, preferably using stainless steel AISI 304.

The anticorrosion material film of internal element 40′ is applied on the face exposed to open air when bumper 10′ is assembled in the vehicle.

According to above statements and drawings attached hereto, it can be observed that this invention process is devised to manufactured a coated fence or bumper in a much more practical, simple and economical manner, but at the same time, more efficient, with all the aesthetical, mechanical and corrosion-resistance characteristics both of chromium-plated bumpers as well as those found in the prior art. Therefore, it will be evident for a technician in this subject that the descriptions previously outlined are made only as an enumeration but not as a limitation of this invention, since it is possible to consider multiple potential changes as to details such as step sequence, materials used to manufacture the bumper, the bumper shapes, among others.

Although the above statements have outlined and depicted a particularly specific description, as well as alternative descriptions for this invention, it must be remarked that multiple potential changes are possible, but without deviating from the true scope of this invention. Therefore, this invention, must not be restricted save for what may be found in the state of the art and in the attached claims, as well.

1.- A process for the manufacture of a coated bumper, which comprises the following steps: (a) stamping of a first metal plate to obtain a base or internal element of the coated bumper, which remains hidden when such bumper is assembled in the vehicle; (b) apply an anticorrosion material film in at least on one of the internal element faces; (c) clean the internal element to remove any type of grease and impurity on their faces; make element undergo a degreasing process to remove dust and any type of grease remaining after application of anticorrosion film; (d) place and adhesive material on the other face of internal element that serves as a coupling agent and selected among spraying (aspersing), the use of a paint-brush, extrusion, immersion, among others; (e) separately stamp a second metal plate to obtain the coating or external element resting in the visible part of the coated bumper when it is assembled in the vehicle; (f) clean the external element to remove any type of grease and impurities remaining on their faces, making it undergo a mechanical cleaning process with solvent and/or detergent solution; next, rinse off and dry; (g) place on the face to be coupled to the external element, the adhesive material selected among spraying (aspersing), use of a paint-brush, extrusion, immersion, among others; (h) assemble the internal element and the external element to shape the coated bumper; for such purpose, the face to be coupled of the external element is coupled on the face to be coupled of the internal element by exerting pressure using a press harness keeping the coupling of both pats with a separation between each other requiring such adhesive for optimal adherence and resistance, which is between 0.02 to 1.2 mm; (i) pre-cure the adhesive material, where the coated bumper obtained at the previous step is subjected to a setting process to achieve maximum adherence and resistance, the duration and temperature of which, depend on the type of adhesive material used to perform assembly; (j) reinforce the coupling of the external element with the internal element through any coupling method selected among locking, clamping, using nuts and bolts, welding points or combinations thereof, among others (k) polish the visible face of the external element to give, or else, recover the “mirror degree” reflective finishing or any other degree damaged during the stamping and, assembling process; polishing can be performed by brushing or any other known mechanical polishing process; (l) visually inspect the coated bumper to detect any appearance or dimension defect since the surface of the visible face must be free of cracks, dents, skin, die marks, etc.; and (m) pack the coated bumper in such a way it is set to be delivered to the assembly facility to assemble it in the vehicle, or else, deliver it to spare part dealers or license holders of assembly facilities trademarks.

2.- The process for the manufacture of a coated bumper according to claim 1, wherein the external element having the same shape as the internal element, but with dimensions slightly greater than such internal element.

3.- The process for the manufacture of a coated bumper according to claim 1, wherein the anticorrosion material is a water-based painting o solvent base; it is applied through any of the methods selected among electro-depositing, aspersing (spraying), immersion, use of a paint-brush or through any other known application method.

4.- The process for the manufacture of a coated bumper according to claim 3, wherein the anticorrosion film is applied on at least one of the faces of internal element or base.

5.- The process for the manufacture of a coated bumper according to claim 3, wherein the anticorrosion film is applied on the face exposed to open air once the bumper is assembled in the vehicle.

6.- The process for the manufacture of a coated bumper according to claim 1, wherein the adhesive material is applied through a extrusion dosing device that following the shape of the part in an automation application, where such face to be couples is the face opposite to the face in contact with open air.

7.- The process for the manufacture of a coated bumper according to claim 1, wherein the adhesive material is selected among acrylic, cyano-acrylate, epoxic, urethanic adhesives, or any other adhesive capable to securely couple metal materials.

8.- The process for the manufacture of a coated bumper according to claim 1, wherein the process used to reinforce the assembly coupling is the locking process.

9.- The process for the manufacture of a coated bumper according to claim 1, wherein the first metal plate is made of carbon steel material selected among Series SAE 10XX steels.

10.- The process for the manufacture of a coated, bumper according to claim 1, wherein the second metal plate is made of stainless steel with an elongation of at least 40%, which is selected among Series 300, stainless steels.

11.- The process for the manufacture of a coated bumper according to claim 1, wherein the manufacturing process comprises the following steps: place the adhesive material on one of the faces of a first metal plate and a second metal plate; (b) couple the first metal plate to the second metal plate by exerting pressure one of them to attain a good coupling with each other, and thus shaping a bi-metal substratum; (c) pre-cure the adhesive material; for that purpose, the bi-metal substratum obtained in the previous step is subjected to a setting process to attain maximum adherence and resistance, where the time and temperature depend on the type of adhesive material used for assembly; (d) stamp the bi-metal substratum to obtain a coated bumper; (e) clean the coated bumper to remove any type of grease or impurities on their faces; for this purpose, the coated bumper is subjected to a mechanical cleaning process with solvent and/or a detergent solution; rinse off and then dry; (f) polish the visible face of the coated bumper to give, or else, recover the “mirror degree” reflective finishing or any other degree damaged during the stamping process; polishing may be performed by brushing or by any other known mechanical polishing process; (g) visually inspect the coated bumper to detect any appearance or dimension defect, since the visible part of the coated bumper must be free of cracks, dents, skin, die marks, etc.; (h) pack the coated bumper in such a way it is set to be delivered to the assembly facility to be assemble in the vehicle, or else, deliver it to the spare part dealers or to the license holders of assembly facilities trademarks.

12.- The process for the manufacture of a bumper coated according to claim 11, wherein the adhesive material is selected among acrylic, cyano-acrylate, epoxic, urethanic adhesives, or any other adhesive capable to securely couple metal materials.

13.- The process for the manufacture of a coated bumper according to claim 11, wherein the first metal plate is made of a carbon steel material selected among Series SAE 10XX steels.

14.- The process for the manufacture of a coated bumper according to claim 11, wherein the second metal plate is made of a stainless steel material with an elongation of at least 40%, which is selected among Series 300 stainless steels.

15.- A bi-metal substratum to manufacture a coated bumper comprised of a first metal plate and a second metal plate securely coupled by an adhesive material.

16.- The bi-metal substratum to manufacture a coated bumper according to claim 15, wherein the adhesive material is selected among, acrylic, cyano-acrylate, epoxic, urethanic adhesives or any other adhesive capable to securely couple metal materials.

17.- A coated bumper comprising the association of an internal element or base located at the internal and hidden part of the bumper when it is assembled in the vehicle, and an external element or coating located on the internal element of bumper, shaping the visible part of such bumper, said internal and external elements area securely coupled by an adhesive material.

18.- The coated bumper according to claim 17, wherein the internal element is of any shape so that it fully covers the front of vehicle for which it was designed.

19.- The coated bumper according to claim 18, wherein the internal element includes in one of its faces at least one anticorrosion material film.

20.- The coated bumper according to claim 19, wherein the anticorrosion material film is applied on the face exposed to open air when bumper is assembled to the vehicle.

21.- The coated bumper according with claim 17, wherein the internal element is manufactured from a carbon steel metal plate selected from Series SAE 10XX steels.

22.- The coated bumper according to claim 17, wherein the external element is of a complimentary shape and dimensions slightly greater than the shape and dimensions of internal element.

23.- The coated bumper according to claim 22, wherein the material emerging as a flap that folds inwards and over the profile of the internal element so that the coupling is reinforced and thus avoiding the external element separates from internal element when coated bumper is assembled in the vehicle and it is already servicing.

24.- The coated bumper according to claim 17, wherein the external element is manufactured from a stainless steel metal substratum with an elongation of at least 40%, so that it loses none of its reflection properties or uniformity of its surface when the material undergoes a stamping process; therefore, such stainless steel is selected among Series 300 stainless steels.

25.- The bumper coated according to claim 17, wherein the adhesive material is selected among acrylic, cyano-acrylate, epoxic, urethanic adhesives or any other adhesive capable to securely couple metal materials.

26.- The coated bumper according to claim 17, wherein the coupling between internal and external elements is reinforced through any coupling method selected between clamping, passers or non passers, nut and bolts, welding, etc.

27.- The coated bumper according to claim 17, wherein the external element is of a different shape than that of the internal element, but perfectly coupling with respect to each other.
